(19) United States
(12) Patent Application Publication
(10) Pub. No.: US 2026/0304090 A1
(43) Pub. Date: Oct. 1, 2026

(54) PORTABLE PUBLIC SAFETY ANSWERING POINT (PSAP)

(71) Applicant: Intrado Life & Safety, Inc., Longmont, CO (US)

(72) Inventor: Kevin Gene Flowers, Sun Valley, NV (US)

(21) Appl. No.: 19/093,949

(22) Filed: Mar. 28, 2025

(51) Int. Cl. H04W 4/90; H04M 3/51; H04W 84/06

(52) U.S. Cl. CPC H04W 4/90; H04M 3/5116; H04M 3/5133; H04W 84/06

(57) ABSTRACT

Particular example embodiments described herein can provide for a system, an apparatus, and a method for helping to enable a portable PSAP. The portable PSAP can include a protective case, auxiliary lighting, status indicator lights, one or more handsets, one or more handset cradles, a communication adapter, an instruction manual, a security pack, a speaker, an ethernet adapter, a power strip, a battery, one or more handset jacks, a communication engine, a PSAP engine, an input keyboard, one or more processors, memory, and/or an antenna. One or more portable PSAPs may be deployed in a remote area, in or around a geofenced event, or in urban areas.

### TECHNICAL FIELD

This disclosure relates in general to the field of computing and/or networking and, more particularly, to a system, an apparatus, and a method to enable a portable public safety answering point (PSAP).

### BACKGROUND

A public-safety answering point (PSAP), sometimes called a public-safety access point, is a call center where emergency/non-emergency calls (like police, fire brigade, ambulance) are received and handled. The PSAP is a call center in almost all countries, including Canada and the United States, where a trained PSAP operator is typically responsible for answering calls to an emergency telephone number for police, firefighting, and ambulance services. In Canada and the United States, counties are generally bound to provide a PSAP and other emergency services, even within municipalities, unless the municipality chooses to opt out and have its own system. Each PSAP has a ‘real’ telephone number that is called when an emergency number (e.g., 911) is dialed or texted. The telecommunications operator is responsible for associating all landline numbers with the most applicable (often the nearest) PSAP, such that when the emergency number is dialed, the call or text is automatically routed to the most suitable PSAP.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIGS. 1A-1D are a simplified block diagrams of a system to enable a portable public safety answering point (PSAP), in accordance with an embodiment of the present disclosure;

FIGS. 2A and 2B are simplified block diagrams of a particular implementation of a portable PSAP, in accordance with an embodiment of the present disclosure;

FIG. 3 is simplified block diagram of a particular implementation of a portable PSAP, in accordance with an embodiment of the present disclosure;

FIG. 4 is a simplified block diagram of a particular implementation of a portable PSAP, in accordance with an embodiment of the present disclosure;

FIGS. 5A-5C are a simplified block diagrams illustrating example details of a portable PSAP, in accordance with an embodiment of the present disclosure;

FIG. 6 is a simplified block diagram illustrating example details of a portable PSAP, in accordance with an embodiment of the present disclosure;

FIG. 7 is a simplified block diagram illustrating example details of a portable PSAP, in accordance with an embodiment of the present disclosure;

FIG. 8 is a simplified block diagram illustrating example details of a portable PSAP, in accordance with an embodiment of the present disclosure;

FIG. 9 is a simplified block diagram illustrating example details of a PSAP input keyboard for use with a portable PSAP, in accordance with an embodiment of the present disclosure;

FIG. 10 is a simplified block diagram illustrating example use details of a security pack for use with a portable PSAP, in accordance with an embodiment of the present disclosure;

FIGS. 11A-11C are simplified block diagrams of a particular implementation of a portable PSAP, in accordance with an embodiment of the present disclosure;

FIG. 12 is a simplified flowchart illustrating potential operations to enable use of a portable PSAP, in accordance with an embodiment of the present disclosure; and

FIG. 13 is a simplified flowchart illustrating potential operations to enable use of a portable PSAP, in accordance with an embodiment of the present disclosure.

The FIGURES of the drawings are not necessarily drawn to scale, as their dimensions can be varied without departing from the scope of the present disclosure.

### DETAILED DESCRIPTION

The following detailed description sets forth examples of apparatuses, methods, and systems relating to enabling a portable PSAP, in accordance with an embodiment of the present disclosure. Features such as structure(s), function(s), and/or characteristic(s), for example, are described with reference to one embodiment as a matter of convenience; various embodiments may be implemented with any suitable one or more of the described features.

### Overview

A public safety answering point (PSAP) is a communication center where emergency/non-emergency communications (calls, texts, IoT device communications) are received and handled. A PSAP operator is typically responsible for answering communications to the PSAP for police, firefighting, and ambulance services. The PSAP operator plays a vital role by assessing if a communication is related to an emergency event, dispatching needed responders to the emergency event, monitoring the responses to the emergency event, and generally coordinating responses to the emergency event. Sometimes, a PSAP center can become non-operational. When that happens, the non-operational PSAP is unable to receive emergency communications and the PSAP operators cannot assess if a communication is related to an emergency event, dispatch needed responders to the emergency event, monitor the responses to the emergency event, and generally coordinate responses to the emergency event.

In an example, a system, method, apparatus, means, etc. can enable a portable PSAP. For example, when a PSAP becomes non-operational, a PSAP operator can use a portable PSAP device to set up a functioning PSAP communication center and allow the PSAP operator to receive communications, communicate with users reporting an event, assess if a communication is related to an emergency event, dispatch needed responders to the emergency event or dispatch emergency services to the emergency event, monitor the responses to the emergency event, and generally coordinate responses to the emergency event. The functioning PSAP communication center can be established in almost any area where communication to the portable PSAP can be established. For example, the communication to the portable PSAP can be satellite communication, cellular communication, landline communication, or some other communication that will allow the portable PSAP to receive emergency communications regarding an emergency event and respond and/or coordinate a response to the emergency event.

### Example Systems, Apparatuses, and Methods

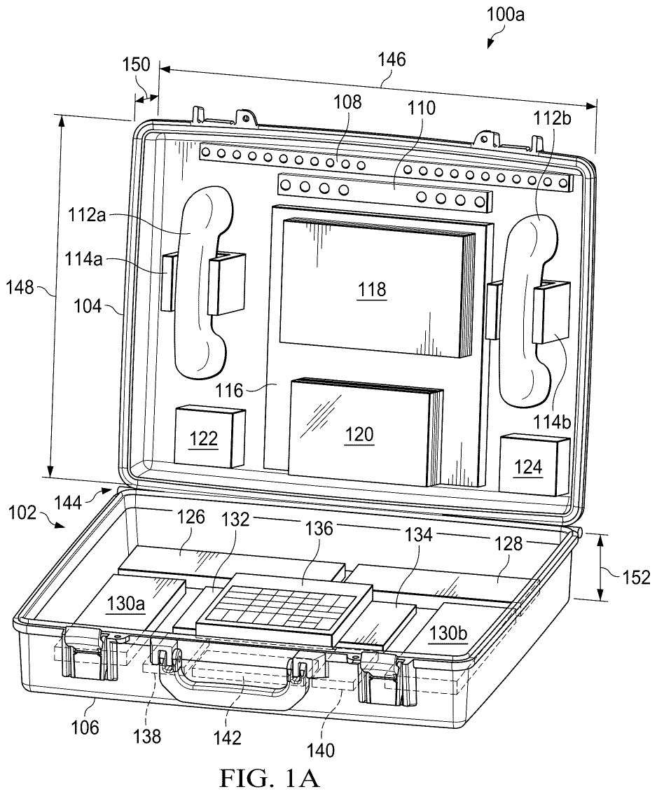

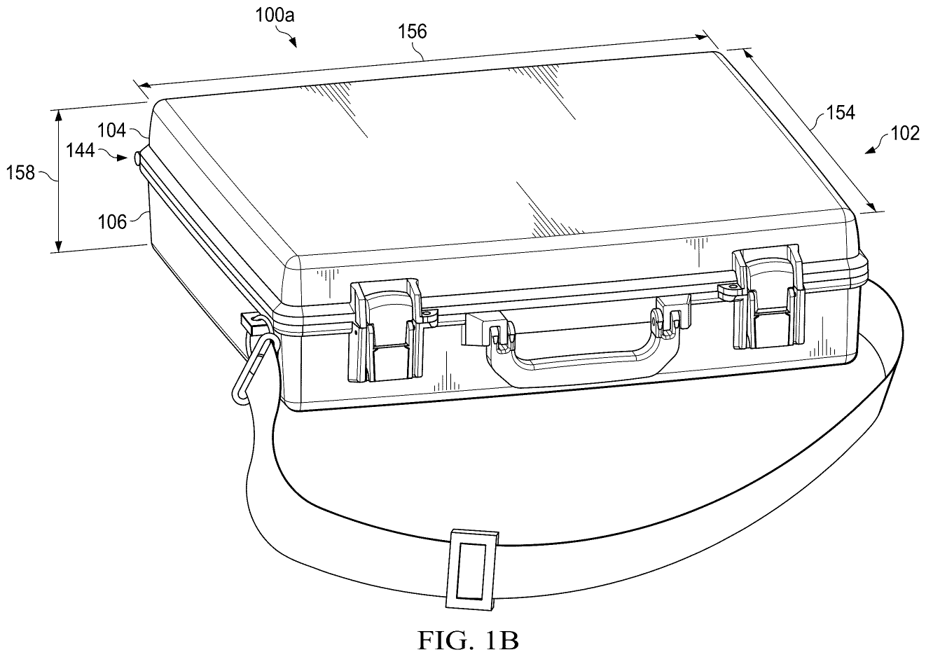

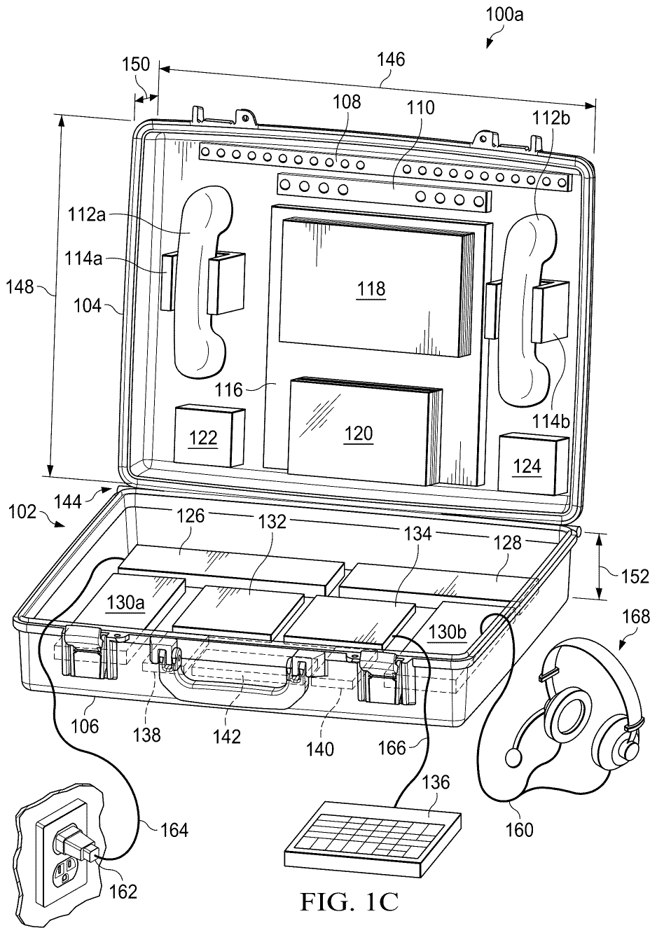

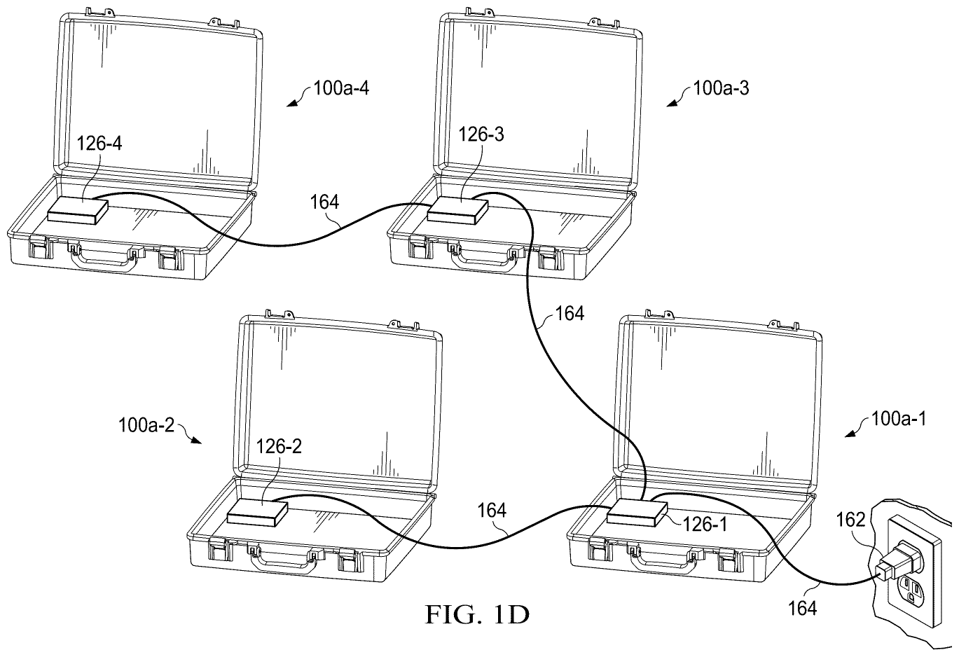

FIG. 1A is simplified block diagram of a particular non-limiting portable public safety answering point (PSAP) system 100a in an open configuration. The portable PSAP system 100a can include a protective case 102. The protective case 102 can include a first portion 104 and a second portion 106 where the first portion 104 and the second portion 106 are rotatably coupled to each other using a hinge 144. The portable PSAP system 100a can help to provide for a mobile PSAP. When closed (as illustrated in FIG. 1B), the protective case 102 can provide protection for the portable PSAP system 100a during storage and allow a PSAP operator to carry the portable PSAP system 100a to a desired location where a functioning PSAP communication center can be established.

In some examples, the first portion 104 of the protective case 102 can have a first portion width 146 between about thirty-two inches (32″) to about twenty inches (20″) and ranges therein, a first portion length 148 between about twenty-two inches (22″) to about ten inches (10″) and ranges therein, and a first portion height 150 between about eight inches (8″) to about two inches (2″) and ranges therein. The length and width of the second portion 106 is the same or about the same (equal to or about equal to) as the first portion width 146 and the first portion length 148 of the first portion 104. The second portion 106 can have a bottom portion height 152 between about between about eight inches (8″) to about two inches (2″) and ranges therein. The first portion height 150 can be the same or about the same (equal to or about equal to) as the bottom portion height 152.

In an example, the first portion 104 can include auxiliary lighting 108, status indicator lights 110, one or more handsets 112 (for example, FIG. 1A illustrates a first handset 112a and a second handset 112b), one or more handset cradles 114 (for example, FIG. 1A illustrates a first handset cradle 114a to support the first handset 112a and a second handset cradle 114b to support the second handset 112b), a communication adapter 116, an instruction manual 118, a security pack 120, a speaker 122, and an ethernet adapter 124. In some examples, one or more of the auxiliary lighting 108, the status indicator lights 110, the one or more handsets 112, the one or more handset cradles 114, the communication adapter 116, the instruction manual 118, the security pack 120, the speaker 122, and the ethernet adapter 124 are located in the second portion 106 of the protective case 102. In some examples, the auxiliary lighting 108 may be located in both the first portion 104 of the protective case 102 and in the second portion 106 of the protective case 102.

The second portion 106 of the protective case 102 can include a power strip 126, a battery 128, one or more handset jacks 130 (for example, FIG. 1A illustrates a first handset jack 130a to electronically couple with the first handset 112a and a second handset jack 130b to electronically couple with the second handset 112b), a communication engine 132, a PSAP engine 134, a PSAP input keyboard 136, one or more processors 138, memory 140, and an antenna 142.

The auxiliary lighting 108 can be configured to provide lighting during use of the portable PSAP system 100a. The status indicator lights 110 can be configured to provide a visual indicator to a PSAP operator for the status of communications to the portable PSAP system 100a. For example, the status indicator lights 110 can include a green light when a communication is active or connected and a red light when a communication has ended or is disconnected.

The one or more handsets 112 can be configured to help enable voice communication between a caller to the portable PSAP system 100a and a PSAP operator. The one or more handsets 112 can be ear and mouth handsets that are connected to (e.g., plug into or hardwired into) the one or more handset jacks 130. In some examples, as illustrated in FIG. 1A, the portable PSAP system 100a can include two handsets, the first handset 112a and the second handset 112b. The first handset 112a and the second handset 112b can be used for PSAP agent training and/or supervision. More specifically, the first handset 112a can be an always on or open microphone handset where a button is pushed or some other means is used to mute the first handset 112a. The second handset 112b can be on mute or have a closed microphone until a button is pushed or some other means is used to talk on the second handset 112b. The first handset 112a can be used by a PSAP operator when responding to a communication to the portable PSAP system 100a. The second handset 112b can be used by a supervisor during training to listen in on the PSAP operator responding to the communication to the portable PSAP system 100a without interrupting the PSAP operator. The one or more handset cradles 114 can be configured to support a handset when the handset is not in use.

The communication adapter 116 can be configured to convert incoming communications to telephony communications and help facilitate communications to and from the portable PSAP system 100a. PSAPs use the public switch telephone network (PSTN) network. When a user communicates (e.g., calls or texts) with a PSAP, the communication is routed through the PSTN, through VOIP, and to the communication adapter 116. More specifically, for incoming communications to the portable PSAP system 100a, the communication adapter 116 can be configured as the interface that converts communications from voice-over-IP to telephony and translates IP packets into voice signals that are sent to the one or more handsets 112. In addition, the communication adapter 116 can convert text communications to audio communications. For outgoing communications, the communication adapter 116 can be configured to convert voice calls and text to digital internet packets for transport over the public switch telephone network (PSTN).

The instruction manual 118 can be configured to provide instructions on how to set up and use the portable PSAP system 100a. During a situation when the portable PSAP system 100a is needed, a PSAP operator can be stressed. The instruction manual 118 can help provide clear instructions on how to set up and use the portable PSAP system 100a.

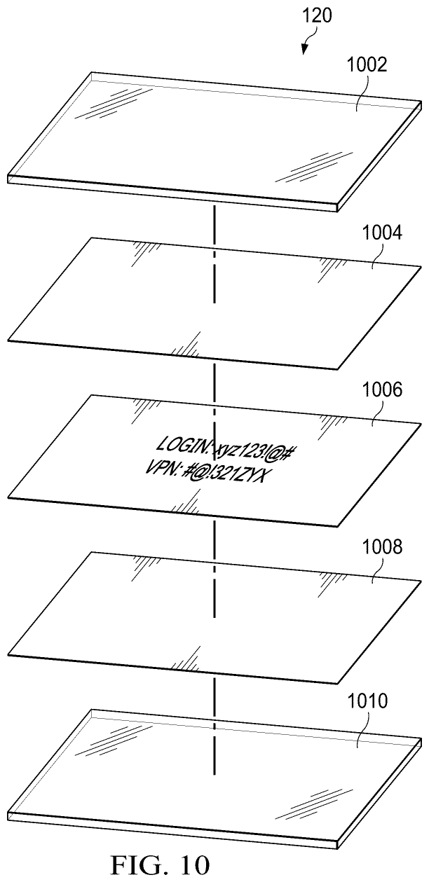

The security pack 120 can be configured to include one or more access codes. More specifically, in an illustrative example, a first access code may be to log into the portable PSAP system 100a and a second access code may be to establish a secure VPN tunnel to the portable PSAP system 100a. The security pack 120 can conceal the one or more access codes until the security pack 120 is opened. Once the security pack 120 is opened, it cannot be reconfigured into the original unopened configuration. An example embodiment of the security pack 120 is illustrated in more detail in FIG. 10.

The speaker 122 can be configured to communicate audio to the PSAP operator. In some examples, the speaker 122 can emit an audio tone or signal when the portable PSAP system 100a receives a new communication. In addition, the speaker 122 can emit an audio tone or signal to alert the PSAP operator when the portable PSAP system 100a requires the PSAP operator's attention. In some examples, the speaker 122 and the auxiliary lighting 108 and/or the status indicator lights 110 can be configured to work together to provide signals and/or alerts to the PSAP operator.

The ethernet adapter 124 can be configured to provide ethernet connectivity between the communication adapter 116, the communication engine 132, and the PSAP engine 134. In some examples, the ethernet adapter 124 also includes relays that control the status indicator lights 110. The power strip 126 can be configured to provide power to the portable PSAP system 100a from a wall outlet or some other power source. The battery 128 can be configured to provide some temporary power to the portable PSAP system 100a

The one or more handset jacks 130 can be configured to electronically couple with a handset 112. For example, FIG. 1A illustrates the first handset jack 130a that can electronically couple with the first handset 112a and the second handset jack 130b that can electronically couple with the second handset 112b.

The communication engine 132 can be configured to help facilitate communications to and from the portable PSAP system 100a. For example, the communication engine 132 can receive a voice input signal from the handset jack 130 and convert the voice input signal to a signal that can be used by the communication adapter 116 to help enable voice communications to and from the portable PSAP system 100a. The PSAP engine 134 can be configured to allow the PSAP operator to respond to communications to the portable PSAP system 100a, help facilitate responses to emergency events, and monitor and coordinate the responses to the emergency event.

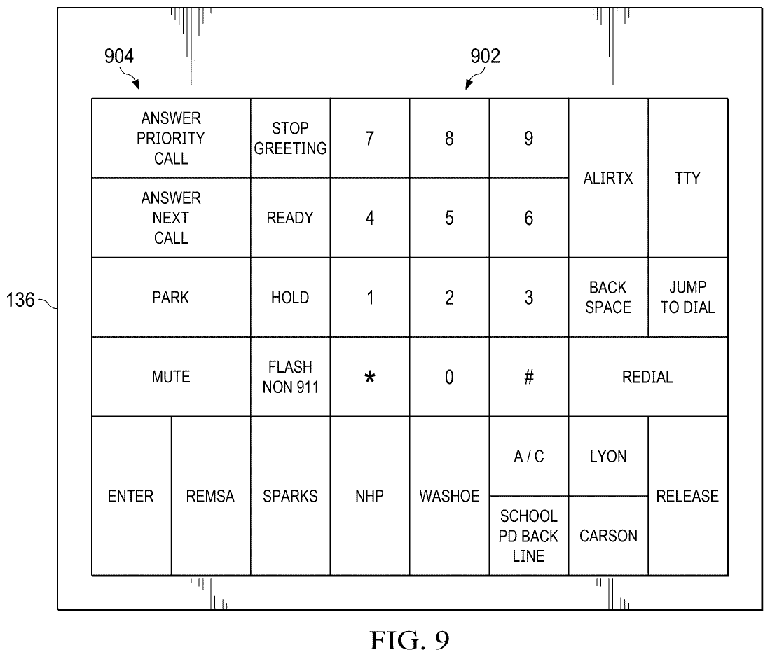

The PSAP input keyboard 136 can be configured to allow a PSAP operator in enter inputs into the portable PSAP system 100a. In some examples, the PSAP input keyboard 136 is a PSAP programmable shortcut keyboard that can include mechanical keys or virtual keys. In an illustrative example, the PSAP input keyboard 136 includes scripts or shortcuts assigned to each button on the PSAP input keyboard 136 to active different agency dials or different commands to the PSAP engine 134. An example embodiment of the PSAP input keyboard 136 is illustrated in more detail in FIG. 9.

The antenna 142 can be configured to help facilitate wireless communications. The wireless communications may be cellular communications, satellite communications or some other wireless communications. The antenna 142 is the interface between radio waves propagating through space and the electric signals used during operation of the portable PSAP system 100a. More specifically, during receiving a wireless communication, the antenna 142 converts received radio waves into an electrical signal to be used by the communication adapter 116 to facilitate communications to and from the portable PSAP system 100a. During transmission, the antenna 142 converts an electrical signal from the communication adapter 116 into radio waves for wireless communication.

Turning to FIG. 1B, FIG. 1B is simplified non-limiting block diagram of the portable PSAP system 100a in a closed stored configuration. In the closed stored configuration, the portable PSAP system 100a can have a portable PSAP system length 154 between about twenty-two inches (22″) to about ten inches (10″) and ranges therein, a portable PSAP system width 156 between about thirty-two inches (32″) to about twenty inches (20″) and ranges therein. The portable PSAP system 100a can have a can have a portable PSAP system height 158 between about between about sixteen inches (16″) to about four inches (4″) and ranges therein. The first portion height 150 is the same or about the same (equal to or about equal to) as the bottom portion height 152 as shown by the first portion height 150 and bottom portion height 152 each being about half the height of the portable PSAP system height 158.

In the close stored configuration, illustrated in FIG. 1B, the protective case 102 can help protect the portable PSAP system 100a and provide for portability of the portable PSAP system 100a. The protective case 102 can help provide protection against impact, dust, water, fire, and/or other types of protection. In some examples, the protective case 102 is waterproof, dustproof, and/or crushproof. To convert the portable PSAP system 100a from the closed stored configuration illustrated in FIG. 1B to an open in use configuration illustrated in FIG. 1C, the first portion 104 is rotated away from the second portion 106 using the hinge 144.

Turning to FIG. 1C, FIG. 1C is simplified block diagram of a particular non-limiting example of the portable PSAP system 100a in an open in use configuration. During use, the PSAP input keyboard 136 can be removed from the protective case 102 to allow a PSAP operator to position the PSAP input keyboard 136 in a desirable location and interact with the PSAP input keyboard 136. The PSAP input keyboard 136 can be in communication with the PSAP engine 134 using a PSAP input keyboard connection 166. In some examples, the PSAP input keyboard connection 166 is a wireless connection (e.g., Bluetooth connection or some other wireless connection).

In an example, a headset 168 can be coupled to one of the one or more handset jacks 130 to allow a PSAP operator to use a preferred headset instead of the handset 112. More specifically, as illustrated in FIG. 1C, the headset 168 is coupled to the second handset jack 130b using headset connection 160. In some examples, the headset connection 160 is a wireless connection (e.g., Bluetooth connection or some other wireless connection). During use, because the battery 128 has a limited amount of power, a power cord 164 can be coupled to a power source 162 and the power strip 126. The power source 162 can be a wall outlet or some other power source that can supply power to the portable PSAP system 100a.

Turning to FIG. 1D, FIG. 1D is simplified block diagram of a particular non-limiting example of multiple portable PSAP systems 100 linked to create a portable PSAP center with multiple PSAP operators responding to communications. For example, as illustrated in FIG. 1D a power strip 126-1 in a portable PSAP system 100a-1 can be coupled to power source 162 to provide power to the portable PSAP system 100a-1. The power source 162 can be a wall outlet, external battery, power generator, or some other power supply that can provide power to the portable PSAP system 100a-1. A power strip 126-2 in a portable PSAP system 100a-2 and a power strip 126-3 in a portable PSAP system 100a-3 can be coupled to the power strip 126-1 in the portable PSAP system 100a-1 to provide power to the portable PSAP systems 100a-2 and 100a-3. A power strip 126-4 in in a portable PSAP system 100a-4 can be coupled to the power strip 126-3 in the portable PSAP system 100a-3 to provide power to the portable PSAP system 100a-4.

It is to be understood that other embodiments and implementations may be utilized, and structural changes may be made without departing from the scope of the present disclosure. Substantial flexibility is provided by the system and method in that any suitable arrangements and configuration may be provided without departing from the teachings of the present disclosure. For purposes of illustrating certain example techniques to enable a portable PSAP, the following foundational information may be viewed as a basis from which the present disclosure may be properly explained.

A PSAP, sometimes called a public-safety access point, is a call center where emergency/non-emergency communications are received. When a communication is sent to a PSAP, a highly trained professional human PSAP operator is expected to respond to the communication. However, PSAP operators are part of an industry under immense pressure because of understaffing and a host of other issues. PSAP centers are struggling with surging call and text volumes, complex compounded emergencies, and insufficient support. Sometimes, a PSAP center can become non-operational. For example, a fire may break out at a PSAP center, an earthquake or some other natural disaster may damage part or all of a PSAP center, a PSAP center may be rendered non-operational by a malicious user that attacks the software of the PSAP center, etc. In some examples, a PSAP center may need to be established in a remote location, for example, to coordinate a search and rescue operation. The equipment in a PSAP center is not designed to be moved and it can be extremely difficult to relocate a PSAP center, especially under stressful situations. What is needed is a system, method, apparatus, means, etc. to allow a PSAP center to be relocated.

A system, method, apparatus, means, etc. to enable a portable PSAP can help resolve these issues (and others). In an example, the portable PSAP an include a communication adapter (e.g., the communication adapter 116) configured to help enable the PSTN connection for PSTN communications to and from the portable PSAP, a PSAP engine (e.g., the PSAP engine 134) configured to allow a PSAP operator to respond to emergency communications and coordinate a response to emergency communications about an emergency event, a PSAP input keyboard (e.g., the PSAP input keyboard 136) configured to allow a PSAP operator to interact with the PSAP engine, and a headset jack (e.g., the headset jack 130) configured to allow a PSAP operator to plug in a handset (e.g., the handset 112) or headset (e.g., the headset 168) to help facilitate voice communications between a PSAP operator and an originator of an emergency communication. In some examples, the portable PSAP can be activated to create a remote PSAP center by establishing a public switch telephone network (PSTN) connection for communications to and from the portable PSAP. The portable PSAP can be moved to a new location to create a new remote PSAP center without losing the established PSTN connection for communications to and from the portable PSAP. In some examples, the portable PSAP also includes a login security code that is used to log into the portable PSAP system and a virtual private network (VPN) connection code that is used to establish a secure VPN tunnel with the portable PSAP system. Multiple other portable PSAPs can be connected to the portable PSAP to allow multiple PSAP operators to respond to emergency communications to the remote PSAP center.

While not in use, the portable PSAP system is stored in a protective case and in the case of a fire or natural disaster, the protective case can protect the portable PSAP from damage. Also, while not in use, the portable PSAP is not connected to a non-portable PSAP center and during a malware attack, the malware will not affect the portable PSAP.

In some examples, during use the portable PSAP is located in a remote location with only satellite-based communications and the portable PSAP uses a satellite communication network to send and receive emergency communications. In some other examples, during use the portable PSAP is located in or near a geofenced area and the portable PSAP uses a cellular network to send and receive emergency communications. The PSAP input keyboard can be a shortcut keypad and may be removable from the portable PSAP.

In an illustrative use example, a PSAP operator can recognize that a portable public safety answering point (PSAP) center has become inoperable, locate a portable PSAP, move the portable PSAP away from the inoperable PSAP center, and activate the portable PSAP to create a new PSAP center away from the inoperable PSAP center. The portable PSAP can include a login security code that is used to log into the portable PSAP system and a virtual private network (VPN) connection code that is used to establish a secure VPN tunnel with the portable PSAP system.

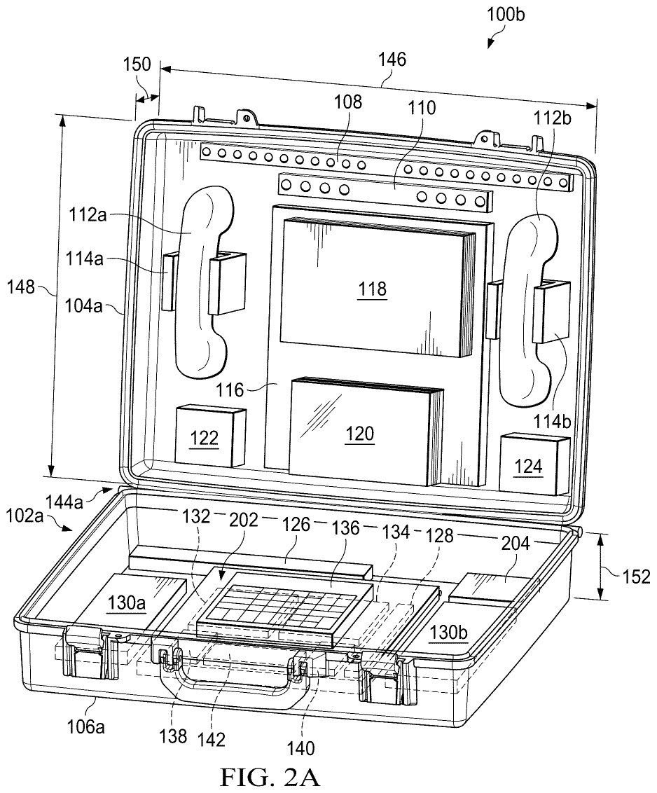

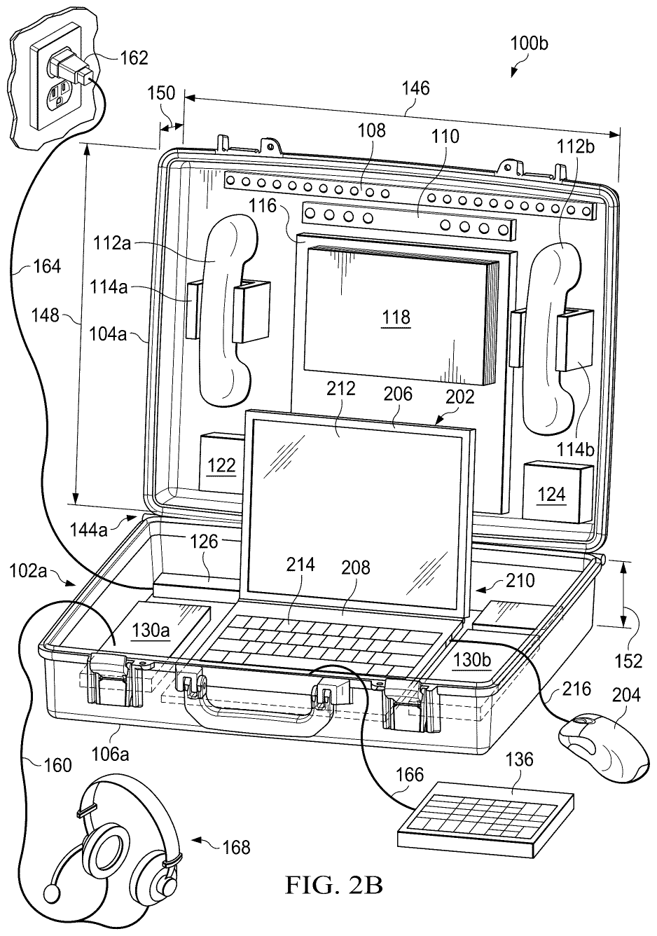

Turning to FIG. 2A, FIG. 2A is a simplified non-limiting block diagram illustrating example details of a portable PSAP system 100b. The portable PSAP system 100b can include a protective case 102a. The protective case 102a can include a first portion 104a and a second portion 106a where the first portion 104a and the second portion 106a are rotatably coupled to each other using a hinge 144a. The portable PSAP system 100b can help to provide a mobile PSAP.

The first portion 104a can include the auxiliary lighting 108, the status indicator lights 110, the one or more handsets 112, the one or more handset cradles 114, the communication adapter 116, the instruction manual 118, the security pack 120, the speaker 122, and the ethernet adapter 124.

The second portion 106a of the protective case 102a can include the power strip 126, the one or more handset jacks 130, the PSAP input keyboard 136, and a laptop computer 202. The laptop computer 202 can include the battery 128, the communication engine 132, the PSAP engine 134, the one or more processors 138, memory 140, and the antenna 142. In some examples, during storage (similar to FIG. 1B), the PSAP input keyboard 136 is over the laptop computer 202.

Turning to FIG. 2B, FIG. 2B is a simplified non-limiting block diagram illustrating example details of the portable PSAP system 100b during use. As illustrated in FIG. 2B, the laptop computer 202 can be opened to allow a PSAP operator to access a display 212 and a laptop keyboard 214 of the laptop computer 202. The laptop computer 202 can include a first laptop housing 206 and a second laptop housing 208. The first laptop housing 206 can be rotatably coupled to the second laptop housing 208 using a laptop hinge 210. The first laptop housing 206 can include the display 212. The second laptop housing 208 can include the laptop keyboard 214. During use, the PSAP operator can use the laptop keyboard 214, the PSAP input keyboard 136, and/or a mouse 204 to enter commands into the portable PSAP system 100b when responding to and coordinating responses to communications to the portable PSAP system 100b.

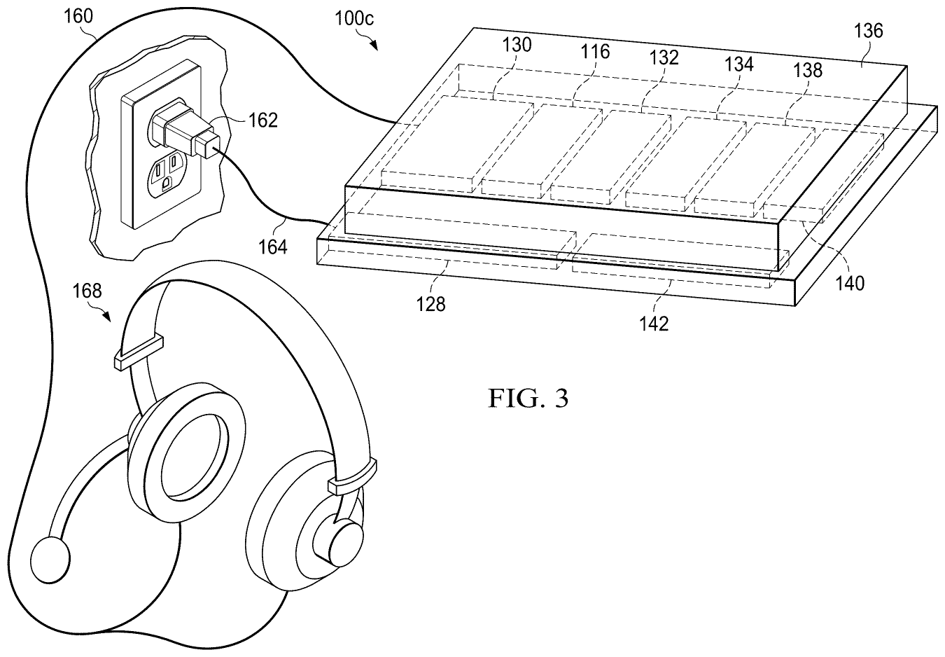

Turning to FIG. 3, FIG. 3 is a simplified non-limiting block diagram illustrating example details of a portable PSAP system 100c. As illustrated in FIG. 3, the portable PSAP system 100c can include the communication adapter 116, the battery 128, the one or more handset jacks 130, the communication engine 132, the PSAP engine 134, the PSAP input keyboard 136, the one or more processors 138, memory 140, and the antenna 142. Note that the portable PSAP system 100c does not include the protective case 102, the auxiliary lighting 108, the status indicator lights 110, the one or more handsets 112, the one or more handset cradles 114, the instruction manual 118, the security pack 120, the speaker 122, the ethernet adapter 124, the power strip 126, or the one or more handset jacks 130.

The portable PSAP system 100c can be a smaller and/or lighter version of the portable PSAP system 100a or 100b. In an example, the headset 168 is coupled to the handset jack 130 using the headset connection 160. In some examples, the headset connection 160 is a wireless connection (e.g., Bluetooth connection or some other wireless connection). During use, because the battery 128 has a limited amount of power, the power cord 164 can be coupled to the power source 162 to supply power to the portable PSAP system 100c. The power source 162 can be a wall outlet or some other power source that can supply power to the portable PSAP system 100c. In some examples, the PSAP input keyboard 136 is not removable from the portable PSAP system 100c.

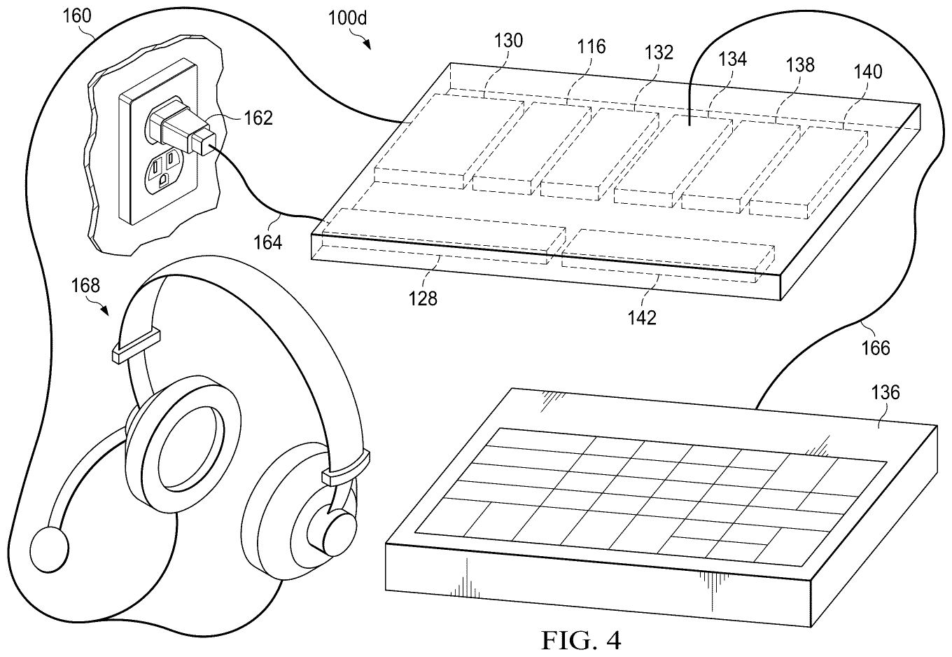

Turning to FIG. 4, FIG. 4 is a simplified non-limiting block diagram illustrating example details of a portable PSAP system 100d. As illustrated in FIG. 4, the portable PSAP system 100d can include the communication adapter 116, the battery 128, the one or more handset jacks 130, the communication engine 132, the PSAP engine 134, the PSAP input keyboard 136, the one or more processors 138, memory 140, and the antenna 142. Note that the portable PSAP system 100d does not include the protective case 102, the auxiliary lighting 108, the status indicator lights 110, the one or more handsets 112, the one or more handset cradles 114, the instruction manual 118, the security pack 120, the speaker 122, the ethernet adapter 124, the power strip 126, or the one or more handset jacks 130.

The portable PSAP system 100d can be a smaller and/or lighter version of the portable PSAP system 100a or 100b. In an example, the headset 168 is coupled to the handset jack 130 using the headset connection 160. In some examples, the headset connection 160 is a wireless connection (e.g., Bluetooth connection or some other wireless connection). During use, because the battery 128 has a limited amount of power, the power cord 164 can be coupled to the power source 162 to supply power to the portable PSAP system 100d. The power source 162 can be a wall outlet or some other power source that can supply power to the portable PSAP system 100d. In some examples, the PSAP input keyboard 136 is removable from the portable PSAP system 100d and the PSAP input keyboard 136 can be in communication with the PSAP engine 134 using the PSAP input keyboard connection 166. In some examples, the PSAP input keyboard connection 166 is a wireless connection (e.g., Bluetooth connection or some other wireless connection).

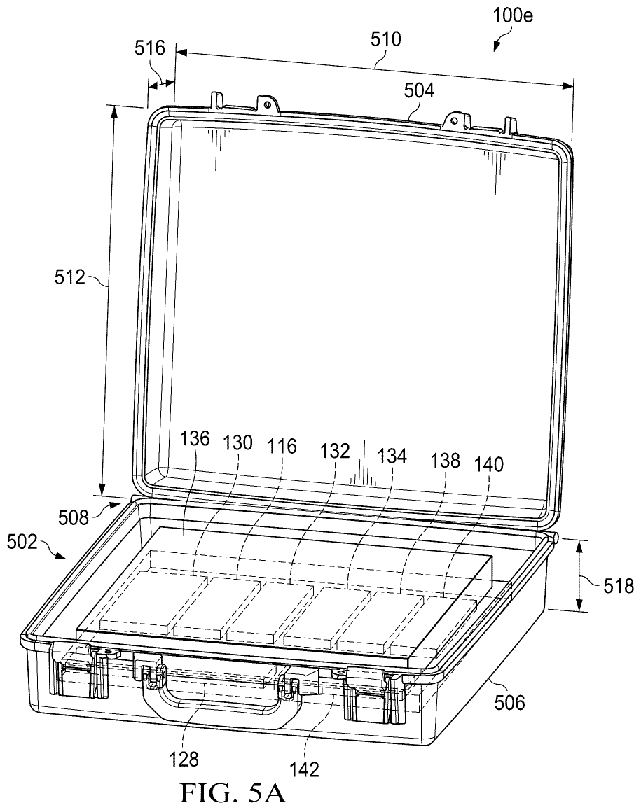

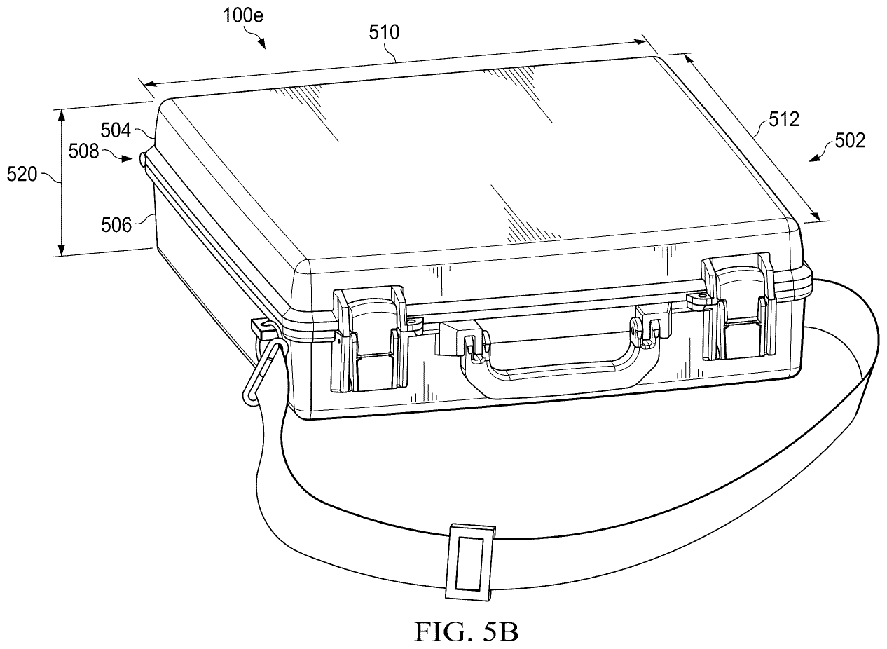

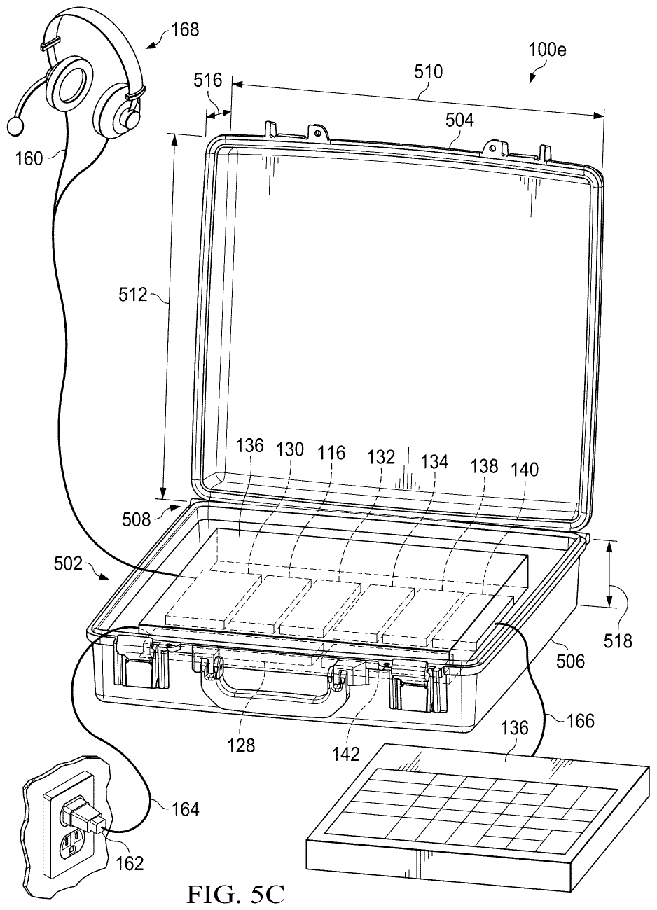

Turning to FIG. 5A, FIG. 5A is a simplified non-limiting block diagram illustrating example details of a portable PSAP system 100e. As illustrated in FIG. 5A, the portable PSAP system 100e can include a protective case 502. The protective case 502 can include a first portion 504 and a second portion 506 where the first portion 504 and the second portion 506 are rotatably coupled to each other using a hinge 508. The portable PSAP system 100e can help to provide for a mobile PSAP. When closed (as illustrated in FIG. 5B), the protective case 502 can provide protection for the portable PSAP system 100e during storage and allow a PSAP operator to carry the portable PSAP system 100e to a desired location where a functioning PSAP communication center can be established.

In some examples, the first portion 504 of the protective case 502 can have a first portion width 510 between about twenty inches (20″) to about ten inches (10″) and ranges therein, a first portion length 512 between about eleven inches (11″) to about four inches (4″) and ranges therein, and a first portion height 516 between about four inches (4″) to about one inch (1″) and ranges therein. The length and width of the second portion 506 is the same or about the same (equal to or about equal to) as the first portion width 510 and the first portion length 512 of the first portion 504. The second portion 506 can have a bottom portion height 518 between about between about four inches (4″) to about one inch (1″) and ranges therein. The first portion height 516 can be the same or about the same (equal to or about equal to) as the bottom portion height 518.

The second portion 506 can include the communication adapter 116, the battery 128, the one or more handset jacks 130, the communication engine 132, the PSAP engine 134, the PSAP input keyboard 136, the one or more processors 138, memory 140, and the antenna 142. Note that the portable PSAP system 100e does not include the auxiliary lighting 108, the status indicator lights 110, the one or more handsets 112, the one or more handset cradles 114, the instruction manual 118, the security pack 120, the speaker 122, the ethernet adapter 124, the power strip 126, or the one or more handset jacks 130. The portable PSAP system 100e can be a smaller and/or lighter version of the portable PSAP system 100a or 100b. In some examples, the PSAP input keyboard 136 is not removable from the portable PSAP system 100e. In some examples, as illustrated in FIG. 5C, the PSAP input keyboard 136 is removable from the portable PSAP system 100e.

Turning to FIG. 5B, FIG. 5B is simplified non-limiting block diagram of the portable PSAP system 100e in a closed stored configuration. In the closed stored configuration, the portable PSAP system 100e can have a first portion width 510 between about twenty inches (20″) to about ten inches (10″) and ranges therein, a first portion length 512 between about eleven inches (11″) to about four inches (4″) and ranges therein, and a portable PSAP system height 520 between about between about eight inches (8″) to about two inches (2″) and ranges therein. The first portion height 516 is the same or about the same (equal to or about equal to) as the bottom portion height 518 as shown by the first portion height 516 and bottom portion height 518 each being about half the height of the portable PSAP system height 520.

In the close stored configuration, the protective case 502 can help protect the portable PSAP system 100e and provide for portability of the portable PSAP system 100e. The protective case 502 can help provide protection against impact, dust, water, fire, and/or other types of protection. In some examples, the protective case 502 is waterproof, dustproof, and/or crushproof. To convert the portable PSAP system 100e from the closed stored configuration illustrated in FIG. 5B to an open and in use configuration illustrated in FIG. 5C, the first portion 504 is rotated away the second portion 506 using the hinge 508.

Turning to FIG. 5C, FIG. 5C is simplified block diagram of a particular non-limiting example of the portable PSAP system 100e an open and in use configuration. During use, the PSAP input keyboard 136 can be removed from the protective case 102 to allow a PSAP operator to position the PSAP input keyboard 136 in a desirable location and interact with the PSAP input keyboard 136. The PSAP input keyboard 136 can be in communication with the PSAP engine 134 using the PSAP input keyboard connection 166. In some examples, the PSAP input keyboard connection 166 is a wireless connection (e.g., Bluetooth connection or some other wireless connection).

In an example, the headset 168 can be coupled to one of the one or more handset jacks 130 to allow a PSAP operator to use a preferred and/or personal headset. More specifically, as illustrated in FIG. 5C, the headset 168 is coupled to the handset jack 130 using the headset connection 160. In some examples, the headset connection 160 is a wireless connection (e.g., Bluetooth connection or some other wireless connection). During use, because the battery 128 has a limited amount of power, the power cord 164 can be coupled to the power source 162 to supply power to the portable PSAP system 100e. The power source 162 can be a wall outlet or some other power source that can supply power to the portable PSAP system 100e.

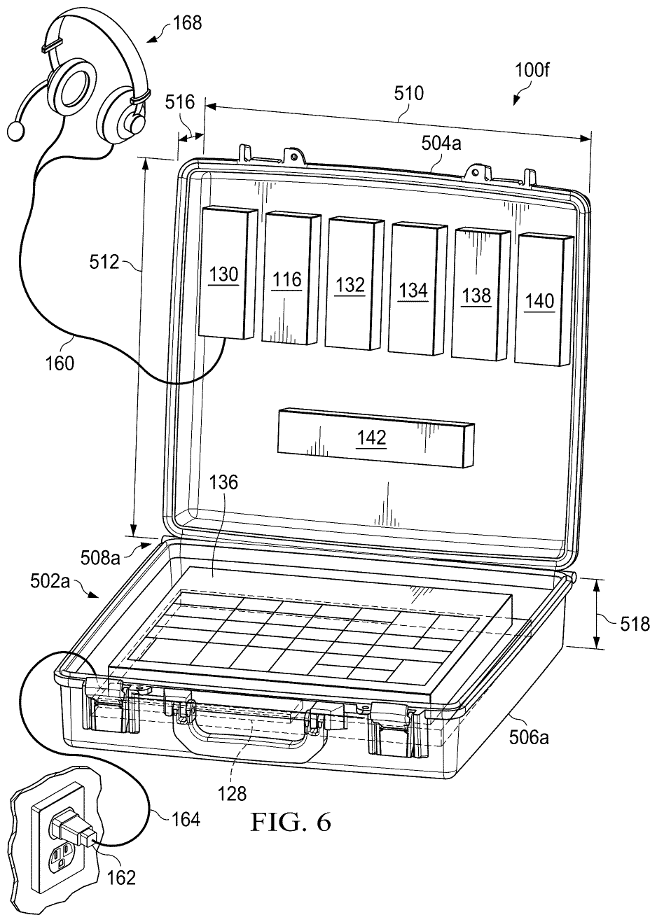

Turning to FIG. 6, FIG. 6 is a simplified non-limiting block diagram illustrating example details of a portable PSAP system 100f. As illustrated in FIG. 6, the portable PSAP system 100f can include a protective case 502a. The protective case 502a can include a first portion 504a and the second portion 506a where the first portion 504a and the second portion 506a are rotatably coupled to each other using a hinge 508a. The portable PSAP system 100f can help to provide for a mobile PSAP. When closed (similar to the closed portable PSAP system 100e as illustrated in FIG. 5B), the protective case 502a can provide protection for the portable PSAP system 100f during storage and allow a PSAP operator to carry the portable PSAP system 100f to a desired location where a functioning PSAP communication center can be established.

In some examples, the first portion 504a of the protective case 502a can have a first portion width 510 between about twenty inches (20″) to about ten inches (10″) and ranges therein, a first portion length 512 between about eleven inches (11″) to about four inches (4″) and ranges therein, and a first portion height 516 between about four inches (4″) to about one inch (1″) and ranges therein. The length and width of the second portion 506a is the same or about the same (equal to or about equal to) as the first portion width 510 and the first portion length 512 of the first portion 504a. The second portion 506a can have a bottom portion height 518 between about between about four inches (4″) to about one inch (1″) and ranges therein. The first portion height 516 can be the same or about the same (equal to or about equal to) as the bottom portion height 518.

The first portion 504a can include the communication adapter 116, the one or more handset jacks 130, the communication engine 132, the PSAP engine 134, the one or more processors 138, memory 140, and the antenna 142. The second portion 506a can include the battery 128 and the PSAP input keyboard 136. Note that the portable PSAP system 100f does not include the auxiliary lighting 108, the status indicator lights 110, the one or more handsets 112, the one or more handset cradles 114, the instruction manual 118, the security pack 120, the speaker 122, the ethernet adapter 124, the power strip 126, or the one or more handset jacks 130. The portable PSAP system 100f can be a smaller and/or lighter version of the portable PSAP system 100a or 100b. In some examples, the PSAP input keyboard 136 is not removable from the portable PSAP system 100f. In some examples, the PSAP input keyboard 136 is removable from the portable PSAP system 100f.

During use, the headset 168 can be coupled to one of the one or more handset jacks 130 to allow a PSAP operator to use a preferred and/or personal headset. More specifically, as illustrated in FIG. 6 the headset 168 is coupled to the handset jack 130 using the headset connection 160. In some examples, the headset connection 160 is a wireless connection (e.g., Bluetooth connection or some other wireless connection). In some examples, the battery 128 can be a rechargeable battery and 164 during use, because the battery 128 has a limited amount of power, the power cord 164 can couple the battery 128 to the power source 162 to supply power to the portable PSAP system 100f. The power source 162 can be a wall outlet or some other power source that can supply power to the portable PSAP system 100f.

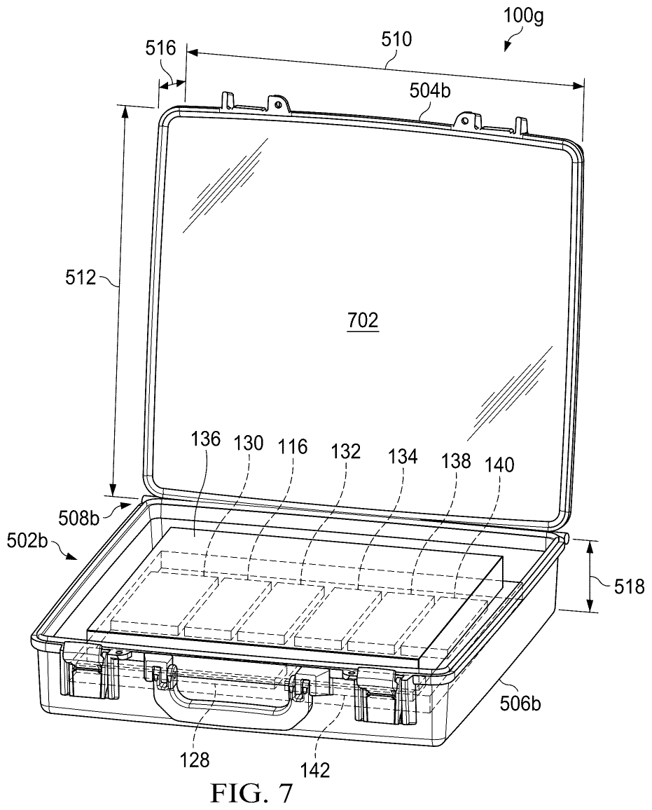

Turning to FIG. 7, FIG. 7 is a simplified non-limiting block diagram illustrating example details of a portable PSAP system 100g. As illustrated in FIG. 7, the portable PSAP system 100g can include a protective case 502b. The protective case 502b can include a first portion 504b and a second portion 506b where the first portion 504b and the second portion 506b are rotatably coupled to each other using a hinge 508b. The portable PSAP system 100g can help to provide for a mobile PSAP. When closed, the protective case 502b can provide protection for the portable PSAP system 100g during storage and allow a PSAP operator to carry the portable PSAP system 100g to a desired location where a functioning PSAP communication center can be established.

In some examples, the first portion 504g of the protective case 502g can have a first portion width 510 between about twenty inches (20″) to about ten inches (10″) and ranges therein, a first portion length 512 between about eleven inches (11″) to about four inches (4″) and ranges therein, and a first portion height 516 between about four inches (4″) to about one inch (1″) and ranges therein. The length and width of the bottom portion 506g is the same or about the same (equal to or about equal to) as the first portion width 510 and the first portion length 512 of the first portion 504. The bottom portion 506g can have a bottom portion height 518 between about between about four inches (4″) to about one inch (1″) and ranges therein. The first portion height 516 can be the same or about the same (equal to or about equal to) as the bottom portion height 518.

The first portion 504b can include a display 702. The display 702 can be configured to display information to a PSAP operator and allow the PSAP operator to provide responses to a communication regarding an event and coordinate responses to the event. In some examples, the display 702 is a touchscreen display.

The second portion 506b can include the communication adapter 116, the battery 128, the one or more handset jacks 130, the communication engine 132, the PSAP engine 134, the PSAP input keyboard 136, the one or more processors 138, memory 140, and the antenna 142. Note that the portable PSAP system 100g does not include the auxiliary lighting 108, the status indicator lights 110, the one or more handsets 112, the one or more handset cradles 114, the instruction manual 118, the security pack 120, the speaker 122, the ethernet adapter 124, the power strip 126, or the one or more handset jacks 130. The portable PSAP system 100g can be a smaller and/or lighter version of the portable PSAP system 100a or 100b. In some examples, the PSAP input keyboard 136 is not removable from the portable PSAP system 100g. In some examples, the PSAP input keyboard 136 is removable from the portable PSAP system 100g.

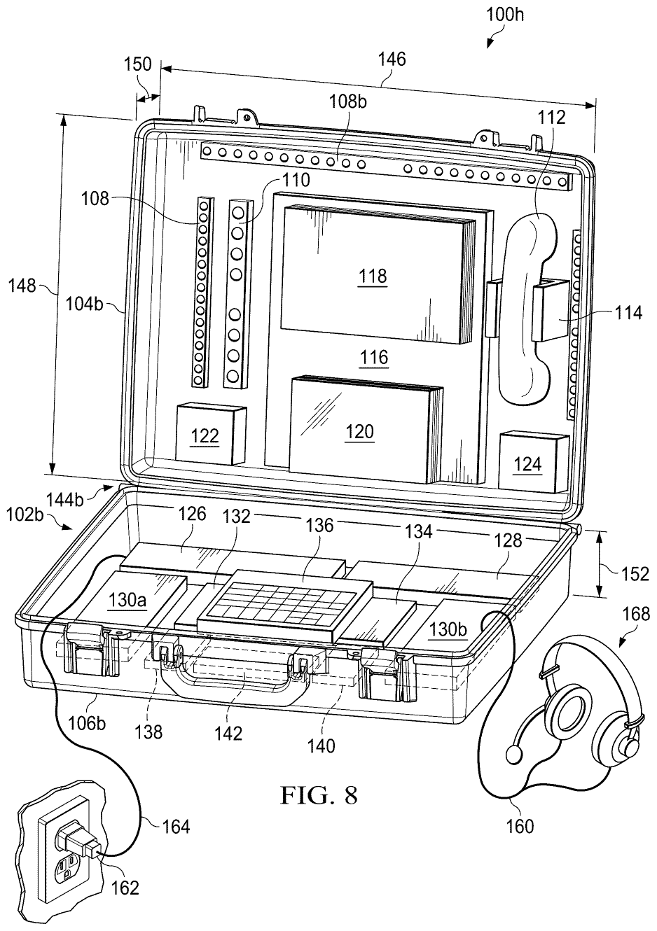

FIG. 8 is simplified block diagram of a particular non-limiting portable public safety answering point (PSAP) system 100h. The portable PSAP system 100h can include a protective case 102b. The protective case 102b can include a first portion 104b and a second portion 106b where the first portion 104b and the second portion 106b are rotatably coupled to each other using a hinge 144b. The portable PSAP system 100h can help to provide for a mobile PSAP. When closed, the protective case 102b can provide protection for the portable PSAP system 100h during storage and allow a PSAP operator to carry the portable PSAP system 100h to a desired location where a functioning PSAP communication center can be established.

In some examples, the first portion 104b of the protective case 102b can have a first portion width 146 between thirty-two inches (32″) to about twenty inches (20″) and ranges therein, a first portion length 148 between about twenty-two inches (22″) to about ten inches (10″) and ranges therein, and a first portion height 150 between about eight inches (8″) to about four inches (4″) and ranges therein. The length and width of the second portion 106b is the same or about the same (equal to or about equal to) as the first portion width 146 and the first portion length 148 of the first portion 104. The second portion 106b can have a bottom portion height 152 between about between about eight inches (8″) to about four inches (4″) and ranges therein. The first portion height 150 can be the same or about the same (equal to or about equal to) as the bottom portion height 152.

In an example, the first portion 104b can include the auxiliary lighting 108, the status indicator lights 110, the handset 112, the handset cradle 114, the communication adapter 116, the instruction manual 118, the security pack 120, the speaker 122, and the ethernet adapter 124. In some examples, one or more of the auxiliary lighting 108, the status indicator lights 110, the one or more handsets 112, the one or more handset cradles 114, the communication adapter 116, the instruction manual 118, the security pack 120, the speaker 122, and the ethernet adapter 124 are located in the second portion 106 of the protective case 102b. In an example, as illustrated in FIG. 8, the auxiliary lighting may be located along the top of the second portion 106b of the protective case 102b and along one or more sides of the second portion 106b of the protective case 102b. In some examples, the auxiliary lighting 108 may be located in both the first portion 104b of the protective case 102b and in the second portion 106b of the protective case 102b. The second portion 106b of the protective case 102b can include the power strip 126, the battery 128, the one or more handset jacks 130, the communication engine 132, the PSAP engine 134, the PSAP input keyboard 136, the one or more processors 138, memory 140, and the antenna 142.

During use of the portable PSAP system 100h, the headset 168 is coupled to the second handset jack 130b (or the first headset jack 130a) using headset connection 160. In some examples, the headset connection 160 is a wireless connection (e.g., Bluetooth connection or some other wireless connection). The power cord 164 can be coupled to the power source 162 and the power strip 126. The power source 162 can be a wall outlet or some other power source that can supply power to the portable PSAP system 100h.

Turning to FIG. 9, FIG. 9 a simplified block diagram illustrating example details of the PSAP input keyboard 136 for use with a portable PSAP. In a non-limiting example, the PSAP input keyboard 136 is a PSAP shortcut keyboard that can include mechanical keys or virtual keys. More specifically, the PSAP input keyboard 136 can include a number keypad 902 and shortcut keys 904. In an illustrative example, the PSAP input keyboard 136 includes scripts or shortcuts assigned to each shortcut keys 904 on the PSAP input keyboard 136 to active different agency dials or different commands to the PSAP engine 134. More specifically, the shortcut keys 904 can include a key to answer a priority call, a key to answer the next call, a key to park a call, a key to mute a call, a key to hold a call, and other shortcut keys that can be used to execute scripts or shortcuts within the system of the portable PSAP system 100.

Turning to FIG. 10, FIG. 10 a simplified block diagram illustrating example details of a security pack for use with a portable PSAP. In a non-limiting example, the security pack 120 can include a first protective layer 1002, a first code obfuscation layer 1004, a security code layer 1006, a second code obfuscation layer 1008, and a second protective layer 1010. The first protective layer 1002 and the second protective layer 1010 can be a hard rigid layer that must be broken to access the one or more security codes on the security code layer 1006. In some examples, the first protective layer 1002 and the second protective layer 1010 are comprised of acrylic or some other material that can be broken by a PSAP operator. By requiring the first protective layer 1002 and the second protective layer 1010 to be broken to access the one or more security codes on the security code layer 1006, once the security pack 120 is opened, it cannot be reconfigured into the original unopened configuration. This allows the ability to know when the portable PSAP system 100 has been accessed. In some examples, once a portable PSAP system 100 has been accessed, the portable PSAP system 100 may undergo testing to ensure malware would not be introduced into a PSAP center if the portable PSAP system 100 is connected to a PSAP center.

The first code obfuscation layer 1004 and the second code obfuscation layer 1008 can obfuscate the one or more security codes on the security code layer 1006. In some examples, the first code obfuscation layer 1004 and the second code obfuscation layer 1008 include a dark color (e.g., black) and/or a pattern that can help obfuscate the one or more security codes on the security code layer 1006. The security code layer 1006 can include one or more security codes. For example, as illustrated in FIG. 10, the one or more security codes on the security code layer 1006 includes a login security code to log into the portable PSAP system 100 and a VPN connection code that can be used to establish a secure VPN tunnel with the portable PSAP system 100.

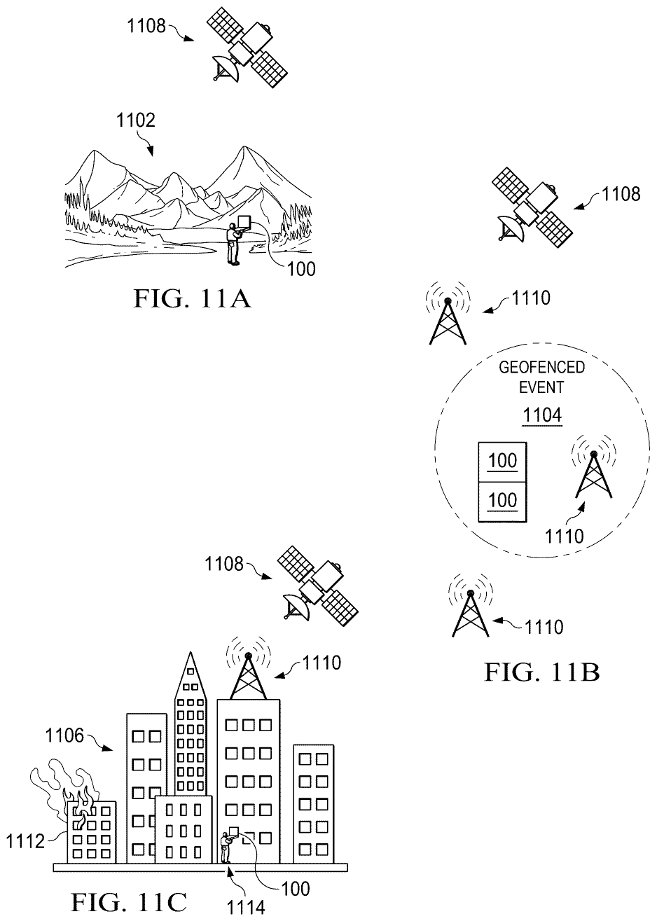

Turning to FIGS. 11A-11C, FIGS. 11A-11C are simplified block diagrams illustrating example use case details of a portable PSAP. As illustrated in FIG. 11A, one or more portable PSAP systems 100 can be deployed to in a remote area 1102. The remote area 1102 is an area where there is no landline connection or cell service. Communications to and from the one or more of the portable PSAP systems 100 in the remote area 1102 can be through satellite communications 1108. In an example, the one or more of the portable PSAP systems 100 in the remote area 1102 can be deployed during a search and rescue operation or some other event in the remote area where there is no landline connection or cell service. In some examples, the remote area may include cellular service or wireless service and the communications to and from the one or more of the portable PSAP systems 100 in the remote area 1102 can be through the cellular service or the wireless service.

As illustrated in FIG. 11B, one or more portable PSAP systems 100 can be deployed to a geofenced event 1104. The geofenced event 1104 is an area where a specific event is occurring, for example, a festive, state fair, concert, rally, major sporting event, a mass shooting, an environmental disaster that covers more than a one hundred feet, or some other event where a relatively large amount of people may be gathered (e.g., over one hundred people) and where response to an emergency event or potential emergency event can be coordinated from inside the geofenced event 1104. Communications to and from the one or more of the portable PSAP systems 100 in or near the geofenced event 1104 can be through satellite communications 1108 and/or cellular communications 1110, if available. By locating one or more portable PSAP systems 100 inside or near the geofenced event 1104, communications that originate inside the geofenced event 1104 can be routed to PSAP operators that are familiar with the conditions and people inside the geofenced event 1104 and response times to emergency events or potential emergency events can be reduced because emergency responders located within the geofenced event 1104 can be dispatched instead of emergency responders that may be located several miles or more away from the geofenced event 1104.

As illustrated in FIG. 11C, one or more portable PSAP systems 100 can be deployed to a location 1114 away from a compromised PSAP center 1112. For example, in an urban area 1106 that includes a PSAP center 1112, the PSAP center 1112 may become non-operational. For example, a fire may break out at the PSAP center 1112, an earthquake or some other natural disaster may damage part or all of the PSAP center 1112, the PSAP center 1112 center may be rendered non-operational by a malicious user that attacks the software of the PSAP center 1112, etc. In the example, when the PSAP center 1112 becomes non-operational, one or more of the portable PSAP systems 100 can be deployed to a location 1114 away from the compromised PSAP center 1112. The location 1114 may be another building or some other location away from the compromised PSAP center 1112 that has power to power the one or more portable PSAP systems 100. Communications to and from the one or more of the portable PSAP systems 100 in the urban area 1106 can be through satellite communications 1108, cellular communications 1110, if available and/or landline communications (not referenced), if available.

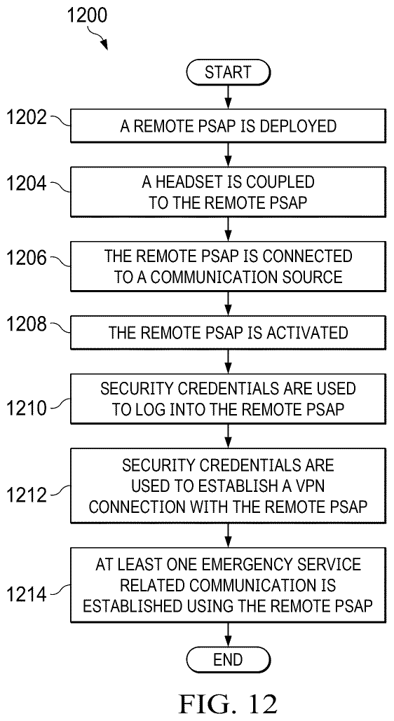

Turning to FIG. 12, FIG. 12 is example flowchart illustrating possible operations of a flow 1200 that may be associated with potential operations to help enable a portable PSAP, in accordance with an embodiment of the present disclosure. Specifically, in some examples, one or more operations of flow 1300 may be performed by the protective case 102, the auxiliary lighting 108, the status indicator lights 110, the one or more handsets 112, the one or more handset cradles 114, the communication adapter 116, the instruction manual 118, the security pack 120, the speaker 122, the ethernet adapter 124, the power strip 126, the battery 128, the one or more handset jacks 130, the communication engine 132, the PSAP engine 134, the PSAP input keyboard 136, the one or more processors 138, memory 140, and/or the antenna 142. At 1202, a remote PSAP is deployed. For example, one or more of the portable PSAP systems 100 may be deployed in the remote area 1102, in or around the geofenced event 1104, or the urban area 1106. At 1204, a headset is coupled to the remote PSAP. At 1206, the remote PSAP is connected to a communication source. At 1208, the remote PSAP is activated. At 1210, security credentials are used to log into the remote PSAP. At 1212, security credentials are used to establish a VPN connection with the remote PSAP. At 124, at least one emergency service related communication is established using the remote PSAP.

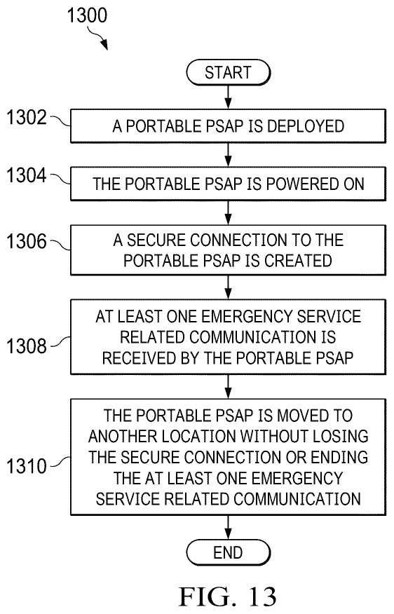

Turning to FIG. 13, FIG. 13 is example flowchart illustrating possible operations of a flow 1300 that may be associated with potential operations to help enable a portable PSAP, in accordance with an embodiment of the present disclosure. Specifically, in some examples, one or more operations of flow 1300 may be performed by the protective case 102, the auxiliary lighting 108, the status indicator lights 110, the one or more handsets 112, the one or more handset cradles 114, the communication adapter 116, the instruction manual 118, the security pack 120, the speaker 122, the ethernet adapter 124, the power strip 126, the battery 128, the one or more handset jacks 130, the communication engine 132, the PSAP engine 134, the PSAP input keyboard 136, the one or more processors 138, memory 140, and/or the antenna 142. At 1302, a portable PSAP is deployed. For example, one or more of the portable PSAP systems 100 may be deployed in the remote area 1102, in or around the geofenced event 1104, or the urban area 1106. At 1304, the portable PSAP is powered on. At 1306, a secure connection to the portable PSAP is created. At 1308, at least one emergency service related communication is received by the portable PSAP. At 1310, the portable PSAP is moved to another location without losing the secure connection or ending the at least one emergency service related communication.

In the description, various aspects of the illustrative implementations are described using terms commonly employed by those skilled in the art to convey the substance of their work to others skilled in the art. However, it will be apparent to those skilled in the art that the embodiments disclosed herein may be practiced with only some of the described aspects. For purposes of explanation, specific numbers, materials, and configurations are set forth in order to provide a thorough understanding of the illustrative implementations. However, it will be apparent to one skilled in the art that the embodiments disclosed herein may be practiced without the specific details. In other instances, well-known features are omitted or simplified in order not to obscure the illustrative implementations.

In the detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense. For the purposes of the present disclosure, the phrase “A and/or B” means (A), (B), or (A and B). For the purposes of the present disclosure, the phrase “A, B, and/or C ” means (A), (B), (C), (A and B), (A and C), (B and C), or (A, B, and C). Reference to “one embodiment” or “an embodiment” in the present disclosure means that a particular feature, structure, or characteristic described in connection with the embodiment is included in at least one embodiment. The appearances of the phrase “in one embodiment” or “in an embodiment” are not necessarily all referring to the same embodiment. Reference to “one example” or “an example” in the present disclosure means that a particular feature, structure, or characteristic described in connection with the embodiment is included in at least one example or embodiment. The appearances of the phrase “in one example” or “in an example” are not necessarily all referring to the same examples or embodiments. The terms “substantially,” “close,” “approximately,” “near,” and “about,” generally refer to being within +/−20% of a target value based on the context of a particular value as described herein or as known in the art.

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur. Substantial flexibility is provided by the system, apparatus, and a method to enable the portable PSAP system 100 in that any suitable arrangements, chronologies, configurations, and timing mechanisms may be provided without departing from the teachings of the present disclosure.

Note that embodiments of the portable PSAP system 100 may include one or more distinct interfaces, represented by any suitable network interfaces to facilitate communication via the various networks (including both internal and external networks) described herein. Such network interfaces may be inclusive of multiple wired and/or wireless interfaces (e.g., Wi-Fi, WiMax, 3G, 4G, 5G+, white space, 802.11x, satellite, Bluetooth, LTE, GSM/HSPA, CDMA/EVDO, DSRC, CAN, GPS, etc.). Other interfaces, may include physical ports (e.g., Ethernet, USB, HDMI, etc.), interfaces for wired and wireless internal subsystems, and the like. Similarly, each of the nodes, can also include suitable interfaces for receiving, transmitting, and/or otherwise communicating data or information in a network environment.

The portable PSAP system 100 and other associated or integrated components can include one or more memory elements for storing information to be used in achieving operations associated with enabling the portable PSAP system 100, as outlined herein. These devices may further keep information in any suitable memory element (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. The information being tracked, sent, received, or stored in the portable PSAP system 100 could be provided in any database, register, table, cache, queue, control list, or storage structure, based on particular needs and implementations, all of which could be referenced in any suitable timeframe. Any of the memory or storage options discussed herein should be construed as being encompassed within the broad term ‘memory element’ as used herein in this Specification.

In example embodiments, the operations for enabling the portable PSAP system 100, outlined herein, may be implemented by logic encoded in one or more tangible media, which may be inclusive of non-transitory media (e.g., embedded logic provided in an ASIC, digital signal processor (DSP) instructions, software potentially inclusive of object code and source code to be executed by a processor or other similar machine, etc.). In some of these instances, one or more memory elements can store data used for the operations described herein. This includes the memory elements being able to store software, logic, code, or processor instructions that are executed to enable the portable PSAP system 100 as described in this Specification. Regarding a physical implementation of the portable PSAP system 100 and its associated components, any suitable permutation may be applied based on particular needs and requirements.

Note that with the examples provided herein, interaction may be described in terms of one, two, three, or more elements. However, this has been done for purposes of clarity and example only. In certain cases, it may be easier to describe one or more of the functionalities by only referencing a limited number of elements. It should be appreciated that the system, apparatus, and a method to enable the portable PSAP system 100 and their teachings are readily scalable and can accommodate a large number of components, as well as more complicated/sophisticated arrangements and configurations. Accordingly, the examples provided should not limit the scope or inhibit the broad teachings of the system, apparatus, and method to enable the portable PSAP system 100 and as potentially applied to a myriad of other architectures.

It is also important to note that the operations in the preceding flow diagrams (i.e., FIGS. 12 and 13) illustrate only some of the possible correlating scenarios and patterns that may be executed, some of these operations may be deleted or removed where appropriate, or these operations may be modified or changed considerably without departing from the scope of the present disclosure. In addition, the timing of these operations may be altered considerably. The preceding operational flows have been offered for purposes of example and discussion. Substantial flexibility is provided in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although the system and method have been illustrated with reference to particular elements and operations, these elements and operations may be replaced by any suitable architecture, protocols, and/or processes that achieve the intended functionality of the system and method.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method comprising:
activating a portable public safety answering point (PSAP) to create a remote PSAP center by establishing a public switch telephone network (PSTN) connection for communications to and from the portable PSAP, wherein the portable PSAP includes:
a communication adapter to help enable PSTN communications to and from the portable PSAP;
a PSAP engine configured to allow a PSAP operator to dispatch emergency services to an emergency;
a PSAP input keyboard; and
a headset jack; and
moving the portable PSAP to create a new remote PSAP center without loosing the established PSTN connection for communications to and from the portable PSAP.

2. The method of claim 1, wherein the portable PSAP also includes a security pack that includes a login security code used to log into the portable PSAP and a virtual private network (VPN) connection code used to establish a secure VPN tunnel with the portable PSAP.

3. The method of claim 2, wherein the portable PSAP is located in a remote location with only satellite-based communications and the portable PSAP uses a satellite communication network to send and receive emergency communications.

4. The method of claim 1, wherein the portable PSAP is located in or near a geofenced area and the portable PSAP uses a cellular network to send and receive emergency communications.

5. The method of claim 1, wherein multiple other portable PSAPs are powered by the portable PSAP to allow multiple PSAP operators to respond to emergency communications to the remote PSAP center.

6. The method of claim 1, wherein the PSAP input keyboard includes shortcut keys and the PSAP input keyboard is removable from the portable PSAP.

7. A portable public safety answering point (PSAP), comprising:
memory;
at least one processor;
a communication adapter to help enable a public switch telephone network (PSTN) connection for communications to and from the portable PSAP;
a PSAP engine configured to allow a PSAP operator to dispatch emergency services to an emergency event;
a PSAP input keyboard; and
a headset jack, wherein a PSAP operator can plug a headset worn by the PSAP operator into the headset jack and communicate with users reporting the emergency event.

8. The portable PSAP of claim 7, wherein the portable PSAP can be moved to a new location without interrupting the PSTN connection for communications to and from the portable PSAP.

9. The portable PSAP of claim 7, wherein the PSAP input keyboard includes shortcut keys to enter commands into the PSAP engine while the PSAP operator is responding to the emergency event.

10. The portable PSAP of claim 7, wherein the portable PSAP is located in a remote location with only satellite-based communications.

11. The portable PSAP of claim 7, wherein the portable PSAP is located in or near a geofenced area with cellular based communications.

12. The portable PSAP of claim 7, wherein the portable PSAP includes a protective case.

13. A method comprising:
recognizing that a public safety answering point (PSAP) center has become inoperable;
locating a portable PSAP and moving the portable PSAP away from the inoperable PSAP center, wherein the portable PSAP includes:
a communication adapter;
a PSAP engine configured to allow a PSAP operator to dispatch emergency services to an emergency;
a PSAP input keyboard; and
a headset jack; and
activating the portable PSAP to create a new PSAP center away from the inoperable PSAP center.

14. The method of claim 13, wherein the portable PSAP also includes security pack that includes a login security code used to log into the portable PSAP and a virtual private network (VPN) connection code used to establish a secure VPN tunnel with the portable PSAP.

15. The method of claim 13, wherein the portable PSAP is moved to a location that allows for a public switch telephone network (PSTN) connection for communications to and from the portable PSAP.

16. The method of claim 13, wherein the portable PSAP uses a cellular network to send and receive emergency communications.

17. The method of claim 13, wherein the portable PSAP uses a satellite communication network to send and receive emergency communications.

18. The method of claim 13, wherein the PSAP input keyboard is removable from the portable PSAP.

19. The method of claim 13, further comprising:
moving the portable PSAP to a new location to create a second new PSAP center.

20. The method of claim 13, wherein the portable PSAP is protected by a protective case.
